(19) United States
(12) Patent Application Publication
(10) Pub. No.: US 2020/0250419 A1
(43) Pub. Date: Aug. 6, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Jun RI, Kanagawa (JP)

(73) Assignee: FUJI XEROX CO., LTD., Tokyo (JP)

(21) Appl. No.: 16/558,167

(22) Filed: Sep. 2, 2019

(30) Foreign Application Priority Data
Jan. 31, 2019 (JP) 2019-015797

(51) Int. Cl. G06K 9/00; G06K 9/34

(52) U.S. Cl. CPC G06K 9/00469; G06K 2209/01; G06K 9/00463; G06K 9/344

(57) ABSTRACT

An information processing apparatus includes an extraction unit that extracts character strings obtained by converting characters in an image to character codes, an aggregation unit that aggregates plural first character strings that are included in the character strings extracted by the extraction unit and each of which represents an item that a user desires to obtain into a group by using information items regarding positions of the plural first character strings in the image, an assigning unit that assigns candidates for a second character string that are included in the character strings extracted by the extraction unit and that correspond to the group aggregated by the aggregation unit to the group, and an output unit that outputs the candidates for the second character string assigned to the group by the assigning unit.

### CROSS-REFERENCE TO RELATED APPLICATIONS

This application is based on and claims priority under 35 USC 119 from Japanese Patent Application No. 2019-015797 filed Jan. 31, 2019.

### BACKGROUND

### (i) Technical Field

The present disclosure relates to an information processing apparatus and a non-transitory computer readable medium.

### (ii) Related Art

There is known an information processing apparatus that extracts, from an image read by a scanner, a character string associated with a specific item which is represented by a specified keyword.

Japanese Unexamined Patent Application Publication No. 2008-192032 discloses a document processing apparatus including a first reading unit that reads a sheet, a marking detector that detects, from data read by the first reading unit, a marking written on a sheet, an attribute-name extraction unit that extracts, as an attribute name, a character string which is written beforehand within or in the vicinity of a marking region of a detected marking, an attribute-information storage unit that stores an attribute name extracted by the attribute-name extraction unit, a second reading unit that reads a sheet on which an attribute value has been written, an attribute-name detector that detects an attribute name stored in the attribute-information storage unit from data read by the second reading unit and determines a position at which the detected attribute name is written, and an attribute-value extraction unit that extracts a character string that is located in the vicinity of the detection position where an attribute name is detected by the attribute-name detector from data read by the second reading unit and registers the extracted character string as an attribute value of the attribute in the attribute-information storage unit such that the extracted character string is associated with the attribute name.

For example, there is a case where it is desired to extract a character string that corresponds to a specific item specified by a user from an image that is obtained as a result of reading, by using a scanner, a drawing such as a circuit diagram in which the positions at which character strings describing the contents of the drawing are written are not fixed and in which the character strings are written at free positions.

However, since the positions at which the character strings are written are not fixed in the image, it is more difficult to determine which one of the character strings is the character string that corresponds to the specific item than in a case where, for example, the character string that corresponds to the specific item is determined from a document in which a field in which a character string is to be written is set beforehand for each item.

### SUMMARY

Aspects of non-limiting embodiments of the present disclosure relate to providing an information processing apparatus and a non-transitory computer readable medium capable of extracting a character string that corresponds to a specific item from an image even if the position of the character string corresponding to the specific item is not set beforehand.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including an extraction unit that extracts character strings obtained by converting characters in an image to character codes, an aggregation unit that aggregates a plurality of first character strings that are included in the character strings extracted by the extraction unit and each of which represents an item that a user desires to obtain into a group by using information items regarding positions of the plurality of first character strings in the image, an assigning unit that assigns candidates for a second character string that are included in the character strings extracted by the extraction unit and that correspond to the group aggregated by the aggregation unit to the group, and an output unit that outputs the candidates for the second character string assigned to the group by the assigning unit.

### BRIEF DESCRIPTION OF THE DRAWINGS

An exemplary embodiment of the present disclosure will be described in detail based on the following figures, wherein:

FIG. 1 is a block diagram illustrating an example of a functional configuration of an information processing apparatus;

FIGS. 2A and 2B are diagrams each illustrating an example of a converted image;

FIG. 3 is a diagram illustrating an example of a keyword table;

FIG. 4 is a diagram illustrating an example of group aggregation;

FIG. 5 is a diagram illustrating a configuration example of a principal portion of an electrical system in the information processing apparatus;

FIG. 6 is a flowchart illustrating an example of a flow of information processing;

FIG. 7 is a flowchart illustrating an example of a flow of aggregation processing;

FIG. 8 is a diagram illustrating an example of a converted image divided into paragraph units; and

FIG. 9 is a diagram illustrating an example of acquisition of value performed by the information processing apparatus.

### DETAILED DESCRIPTION

An exemplary embodiment of the present disclosure will be described below with reference to the drawings. Note that, in the drawings, components having the same function are denoted by the same reference sign, and processing operations having the same function are denoted by the same reference sign. Repeated descriptions will be avoided.

### Exemplary Embodiment

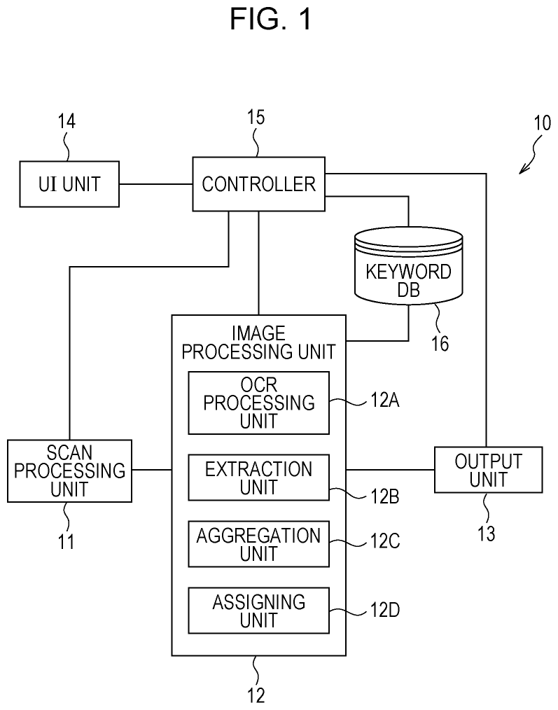

FIG. 1 is a block diagram illustrating an example of a functional configuration of an information processing apparatus 10 that extracts and outputs a character string that corresponds to a specific item specified by a user from a document that is obtained by, for example, performing optical character recognition (OCR) processing on an image that is formed by optically reading the contents of a document.

The information processing apparatus 10 includes functional units including a scan processing unit 11, an image processing unit 12, an output unit 13, a user interface (UI) unit 14, and a controller 15 and a keyword database (DB) 16.

The scan processing unit 11 generates an image that corresponds to a document (hereinafter simply referred to as “image”) by using a scanner unit 50, which optically reads the contents written in the document, and transmits the generated image to the image processing unit 12.

Although there is no limitation on a document that is read by the scanner unit 50, for example, the scanner unit 50 reads a document in which the positions at which character strings are written are not fixed and in which the character strings are arranged at free positions in accordance with a user's intention. For example, in a circuit diagram or an explanatory diagram, although character strings are written together with a diagram that describes the contents of the diagram, the character strings are written in a margin of the diagram so as not to overlap the diagram. Thus, the positions at which the character strings are written are often not set. Accordingly, a document in which the positions at which character strings are written are not set will hereinafter be particularly referred to as “drawing”.

The image processing unit 12 includes an OCR processing unit 12A, an extraction unit 12B, an aggregation unit 12C, and an assigning unit 12D.

After the image processing unit 12 has received an image of a drawing from the scan processing unit 11, the image processing unit 12 first performs commonly known image recognition on the image by using the OCR processing unit 12A, and converts regions of the image that correspond to characters into character codes. In other words, the character regions of the image are caused to be treated as character codes by the OCR processing unit 12A, and this enables copying and searching of characters. Converted data that is obtained as a result of the character regions included in the image being converted into character codes by the OCR processing unit 12A will hereinafter be referred to as “converted image 20”. The position of each character in the converted image 20 is the same as that in the image, and thus, the positions at which the characters are written in the converted image 20 correspond to the positions at which the characters are written in the image.

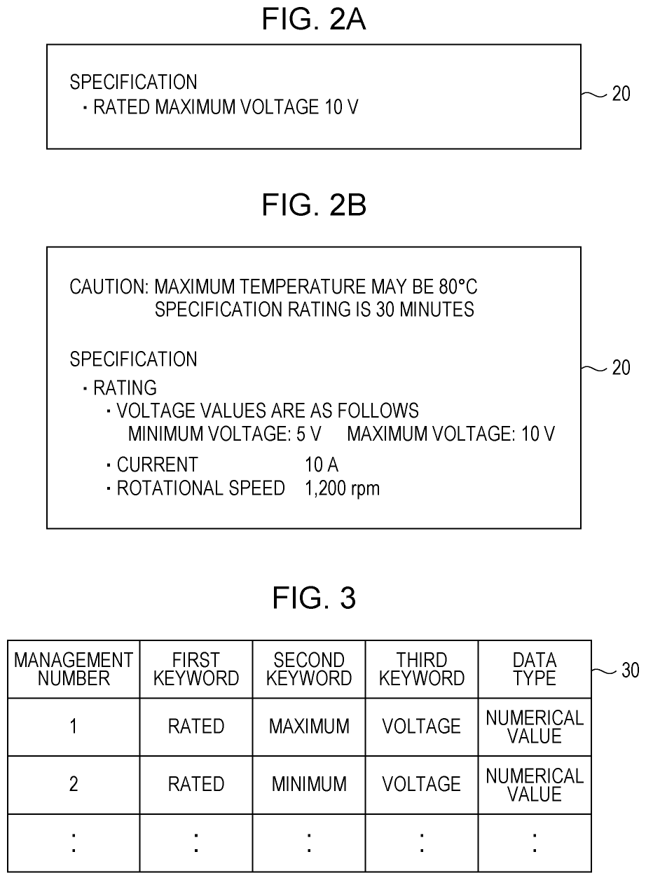

FIGS. 2A and 2B are diagrams each illustrating an example of the converted image 20. As illustrated in FIGS. 2A and 2B, the converted image 20 includes character strings each of which is represented by a character code. In the drawing, various information items such as dimensions and performances are written, and as mentioned above, it is not determined beforehand where and in what format an information item needed by a user is written in the drawing. Thus, the information processing apparatus 10 outputs an information item that corresponds to an item specified by the user as an acquisition target among the information items included in the drawing.

Thus, the extraction unit 12B extracts a character string representing the item that the user desires to obtain from the converted image 20, which has been generated by the OCR processing unit 12A, by referencing to the character codes. In the following description, a character string representing an item that a user desires to obtain will be referred to as “keyword”. For example, when the drawing is a diagram illustrating some sort of device, and when a rated maximum voltage of the device is desired to obtain the drawing, a character string “RATED MAXIMUM VOLTAGE” is designated as a keyword in the information processing apparatus 10.

As illustrated in FIG. 2A, when the converted image 20 includes a character string that matches the keyword “RATED MAXIMUM VOLTAGE”, it is determined that “RATED MAXIMUM VOLTAGE” is written in the converted image 20 by only comparing the keyword and the character string, and the character string that corresponds to the keyword and that represents the contents of the keyword (hereinafter referred to as “value”) is obtained. More specifically, in the case illustrated in FIG. 2A, “10 V” is the value of the keyword “RATED MAXIMUM VOLTAGE”. The value is an example of a second character string in the technology disclosed herein.

However, in a drawing in which a character string is written at a free position in accordance with a user's intention, there may be a case where the rated maximum voltage is written as illustrated in FIG. 2B. In the case illustrated in FIG. 2B, the “RATED MAXIMUM VOLTAGE” is divided into the words “RATED”, “MAXIMUM”, and “VOLTAGE”, and these words are written in different lines. In this case, “VOLTAGE VALUES ARE AS FOLLOWS” is written above the line in which “MAXIMUM VOLTAGE: 10 V” is written, and in addition, “RATING” is written above “VOLTAGE VALUES ARE AS FOLLOWS”. Thus, it is understood by a human being that “10 V” is written as the value of the rated maximum voltage in the converted image 20 illustrated in FIG. 2B. However, when “RATED MAXIMUM VOLTAGE” is designated as a keyword, since the character string “RATED MAXIMUM VOLTAGE” is not present in the converted image 20 illustrated in FIG. 2B, the value of the rated maximum voltage will not be obtained from the converted image 20 illustrated in FIG. 2B.

Thus, the information processing apparatus 10 further divides a keyword into words and manages the keyword in the form of character strings, which are obtained by dividing the keyword into words (hereinafter referred to as “individual keywords”). Note that although a keyword may be divided into units other than words, a situation in which a keyword is divided into words will be described as an example. Each individual keyword is an example of a first character string in the technology disclosed herein.

FIG. 3 is a diagram illustrating an example of a keyword table 30 that is managed in the keyword DB 16. In the keyword table 30, individual keywords that are included in keywords each specified by a user are managed so as to be associated with one another for each keyword. For example, a keyword “RATED MAXIMUM VOLTAGE” is divided into a first keyword, a second keyword, and a third keyword, and “RATED”, “MAXIMUM”, and “VOLTAGE” are respectively associated with the first keyword, the second keyword, and the third keyword.

In addition, management numbers that are assigned to the keywords such that the keywords do not overlap one another are each associated with one of the keywords in order to identify the keywords. When the keyword whose management number “1” is selected, the individual keywords that form the keyword “RATED MAXIMUM VOLTAGE” are selected. When the keyword whose management number is “2” is selected, the individual keywords that form the keyword “RATED MINIMUM VOLTAGE” are selected.

Furthermore, a data type is associated with each of the keywords. The term “DATA TYPE” refers to the form in which the value of a corresponding keyword is represented. Examples of the form in which the value is represented include a numerical value, a character, and a truth value.

In the case of the keyword “RATED MAXIMUM VOLTAGE”, since the voltage is represented by “10 V” which includes a numerical value, “NUMERICAL VALUE” is set as the data type. Note that, symbols such as “◯” and “Δ” are also included in the characters that are used for the data type, and thus, another data type such as “SYMBOL” may be provided. In addition, the characters that are used for the data type may be subdivided into segments such as, for example, “English letters”, “Kanji”, “Hiragana”, “Katakana”, and “Kanji and Hiragana”. Note that, for example, instead of the form in which the value is represented, the meaning of the value such as “date” or “age” may be set to the data type.

Although FIG. 3 illustrates a case in which a keyword is managed by three individual keywords, which are the first to third keywords, the number of the individual keywords managed in the keyword table 30 changes in accordance with the number of words included in the corresponding keyword. Thus, for example, regarding a keyword that cannot be divided into words any more, or a keyword that makes sense by continuously writing a series of words forming the keyword into a drawing without separating the series of words from one another, each of these keywords may be managed as a single individual keyword. In this case, there is one individual keyword that corresponds to the keyword. A case in which a keyword is divided into a plurality of individual keywords will be described below.

The extraction unit 12B acquires individual keywords that correspond to a management number selected by a user from the keyword table 30 of the keyword DB 16 and extracts the acquired individual keywords form the converted image 20.

The aggregation unit 12C aggregates the extracted individual keywords into a group by using positional information of each of the individual keywords extracted from the converted image 20 by the extraction unit 12B, the group including one of each individual keyword associated with the management number selected by the user and including the individual keywords that are positioned as close together as possible.

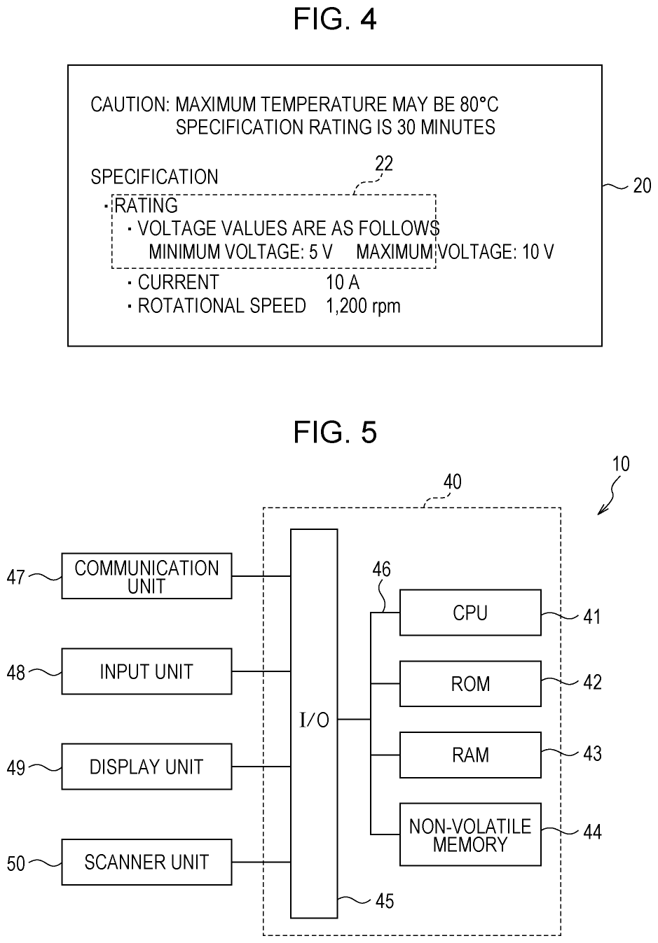

FIG. 4 is a diagram illustrating an example of group aggregation in the case where one of the keywords illustrated in FIG. 3, the keyword having the management number of “1”, that is, the keyword “RATED MAXIMUM VOLTAGE”, is selected by a user as a keyword that is to be extracted from the converted image 20 illustrated in FIG. 2B.

In this case, the individual keywords “RATED”, “MAXIMUM”, and “VOLTAGE” are extracted from the converted image 20, and thus, the aggregation unit 12C sets a rectangle 22 in which the individual keywords that are positioned as close together as possible are included and generates a group in which the individual keywords included in the rectangle 22 are aggregated.

Note that a method of generating a group that is employed by the aggregation unit 12C will be described in detail later. Since the rectangle 22 aggregates the extracted individual keywords, the rectangle 22 is a virtual region, and the data of the rectangle 22 is not added to the converted image 20.

In the rectangle 22, the character strings forming the keyword “RATED MAXIMUM VOLTAGE” are included in a distributed manner so as to be closer to one another than in the other regions. This implies that, in the area of the rectangle 22, the probability that the keyword may be written in a different representing manner is higher than in the other regions. Accordingly, it is very likely that the value of the keyword is written in the vicinity of the area indicated by the rectangle 22 compared with the other regions.

Thus, the extraction unit 12B extracts character strings in the vicinity of the group aggregated by the aggregation unit 12C from the converted image 20, and the assigning unit l2D assigns a character string included in the character strings extracted by the extraction unit 12B, that is, a value candidate that is presumably the value corresponding to the group, to the group. The number of value candidates of a keyword is not limited to one, and a plurality of value candidates may sometimes be assigned to a group. The assigning unit 12D assigns an evaluation value to each value candidate, the evaluation value indicating the likelihood that the assigned value candidate is the value of the keyword, in accordance with the degree of association between the value candidate and the individual keywords included in the group. Note that a method of assigning a value candidate to a group and a method of calculating the evaluation value of a value candidate that are employed by the assigning unit l2D will be described in detail later.

The assigning unit 12D transmits, to the output unit 13, a keyword specified by the user, a value candidate of the keyword obtained by aggregating the individual keywords of the keyword into a group, and the evaluation value of the value candidate.

After the output unit 13 has received the keyword and the value candidate accompanied by the evaluation value from the assigning unit 12D of the image processing unit 12, the output unit 13 outputs an extraction result for the keyword. Here, a combination of the keyword and the value candidate accompanied by the evaluation value is referred to as the “extraction result for the keyword”.

In addition, the wording “outputs an extraction result for the keyword” refers to making the value candidate of the keyword recognizable. The value candidate of the keyword is not limited to being recognized by a person and may be recognized by a device. Thus, each of the following operations corresponds to the output of the extraction result for the keyword: displaying the value candidate onto a display device while associating the value candidate with the keyword, printing the value candidate onto a sheet while associating the value candidate with the keyword, indicating the value candidate by voice while associating the value candidate with the keyword, storing the value candidate into a storage device while associating the value candidate with the keyword, and transmitting the value candidate from a communication unit 47, which will be described later, through a communication line (not illustrated) while associating the value candidate with the keyword.

The UI unit 14 receives an instruction from a user and informs the user of various information items such as the operation of the information processing apparatus 10 and the state of the information processing apparatus 10. For example, the UI unit 14 receives, from a user, instructions regarding registration of a keyword into the keyword DB 16, change of a keyword, and deletion of a keyword and the management number of a keyword whose value is desired to be acquired and informs the user of an extraction result for a specified keyword.

The controller 15 controls processing operations that are performed by the functional units, which are the scan processing unit 11, the image processing unit 12, the output unit 13, and the UI unit 14, and performs control of dividing a keyword received from the UI unit 14 into individual keywords and registering the individual keywords into the keyword DB 16. Note that the user may input an individual keyword to the UI unit 14. In this case, the controller 15 registers the receive individual keyword into the keyword DB 16 without dividing the individual keyword.

FIG. 5 is a diagram illustrating a configuration example of a principal portion of an electrical system in the information processing apparatus 10. For example, the information processing apparatus 10 is formed by using a computer 40.

The computer 40 includes a central processing unit (CPU) 41 that is in charge of each of the functional units according to the present exemplary embodiment, read only memory (ROM) 42 that stores an information-processing program, random access memory (RAM) 43 that is used as a temporary work area for the CPU 41 a non-volatile memory 44, and an input/output (I/O) interface 45. The CPU 41, the ROM 42, the RAM 43, the non-volatile memory 44, and the I/O interface 45 are connected to one another via a bus 46.

The non-volatile memory 44 is an example of a storage device that maintains information stored therein even when supply of power to the storage device is discontinued. Although, for example, a semiconductor memory is used as the non-volatile memory 44, a hard disk may be used as the non-volatile memory 44. The non-volatile memory 44 is not necessarily built into the computer 40 and may be a storage device, such as a memory card, that is attached to and detached from the computer 40. For example, the keyword table 30 is stored in the non-volatile memory 44.

For example, the communication unit 47, an input unit 48, a display unit 49, and the scanner unit 50 are connected to the I/O interface 45.

The communication unit 47 is connected to a communication line (not illustrated) and includes a communication protocol for communicating with an external device, such as a storage device or a computer, that is connected to a connection line (not illustrated). Examples of the communication line (not illustrated) include commonly known communication lines such as the Internet, a local area network (LAN), and a universal serial bus (USB). The communication unit 47 further includes, for example, an interface such as a memory card slot for reading and writing information from and to a semiconductor.

The input unit 48 is a device that receives an instruction from a user and informs the CPU 41 of the instruction, and for example, a button, a touch panel, a keyboard, a mouse, or the like is used as the input unit 48. The information processing apparatus 10 may receive an audio instruction from a user, and in this case, a microphone is connected to the I/O interface 45.

Note that, in order to respond to an instruction from a user at a location spaced apart from the information processing apparatus 10, the information processing apparatus 10 is capable of receiving an instruction from a user not only from the input unit 48 but also from an external device that is connected to the communication unit 47 through the communication line (not illustrated).

The display unit 49 is a device that displays information processed by the CPU 41 as an image, and for example, a liquid crystal display, an electro luminescence (EL) display, a projector that projects an image onto a screen, or the like is used as the display unit 49.

The scanner unit 50 is a device that optically reads, for example, the contents of a drawing placed on a platen glass (not illustrated) in accordance with an instruction from the CPU 41 and converts the contents of the drawing into an image. The scanner unit 50 is used in the processing that is performed by the scan processing unit 11.

In the information processing apparatus 10, although the scan processing unit 11 receives an image read by the scanner unit 50, the scan processing unit 11 does not necessarily receive an image of a drawing from the scanner unit 50, which is connected to the I/O interface 45. For example, the information processing apparatus 10 may receive an image of a drawing from a scanner device (not illustrated) which is an example of an external device connected to the communication unit 47 through the communication line (not illustrated) or a USB interface. The information processing apparatus 10 may also receive an image of a drawing stored in a cloud server.

If the information processing apparatus 10 is configured to receive an image of a drawing through the communication unit 47, it is not necessary for the information processing apparatus 10 to include the scanner unit 50. In this case, as the information processing apparatus 10, an information device, such as a desktop computer, a tablet computer, a smartphone, or a wearable terminal, that includes an input/output device that provides an interface between the device and a user and that has a processing function of processing information which is input thereto is used.

Note that the units connected to the I/O interface 45 are not limited to the units that are illustrated as an example in FIG. 5. For example, an image forming unit that forms processed information onto a recording medium in accordance with an instruction from the CPU 41 may be connected to the I/O interface 45.

Operation of the information processing apparatus 10 that receives an image of a drawing and outputs an extraction result for a keyword specified by a user will now be described.

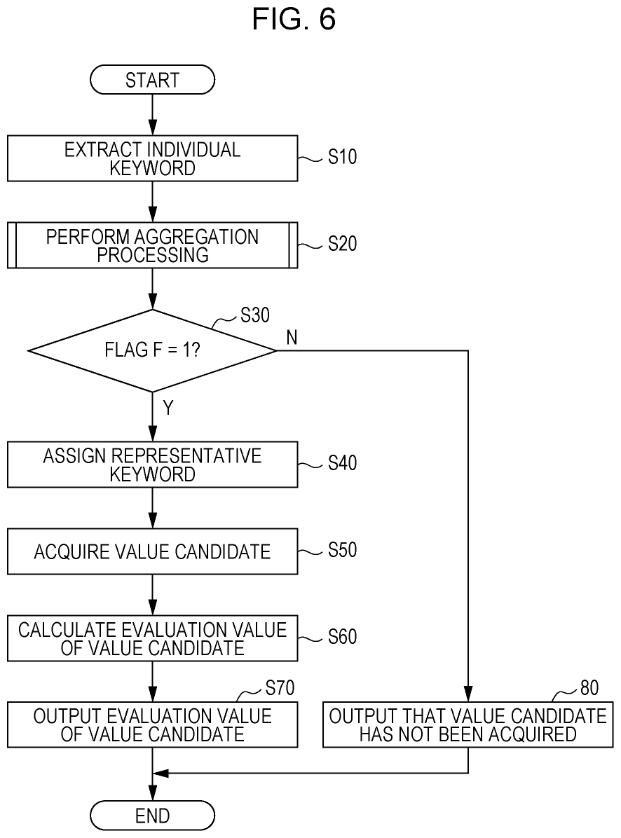

FIG. 6 is a flowchart illustrating an example of a flow of information processing that is performed by the CPU 41 when an image of a drawing received from a user is converted into the converted image 20 by the OCR processing unit 12A. For example, an information-processing program that defines information processing is stored beforehand in the ROM 42 of the information processing apparatus 10. The CPU 41 of the information processing apparatus 10 reads the information-processing program stored in the ROM 42 and performs the information processing.

Note that individual keywords that correspond to a keyword are registered beforehand in the keyword table 30, and a user inputs a keyword that is an acquisition target by specifying the management number of a keyword corresponding to the value that is desired to be acquired.

In step S10, the CPU 41 acquires the individual keywords that correspond to the management number specified by the user by referencing to the keyword table 30 of the keyword DB 16 and extracts the individual keywords from the converted image 20. In this case, the CPU 41 may extract all the character strings that are included in the converted image 20 and stores the character strings into the RAM 43, and then, the CPU 41 may re-extract the individual keywords from the extracted character strings.

In step S20, in order to determine the position at which the specified keyword is written in the converted image 20, the CPU 41 performs aggregation processing for aggregating the individual keywords, which have been extracted in step S10, into a group.

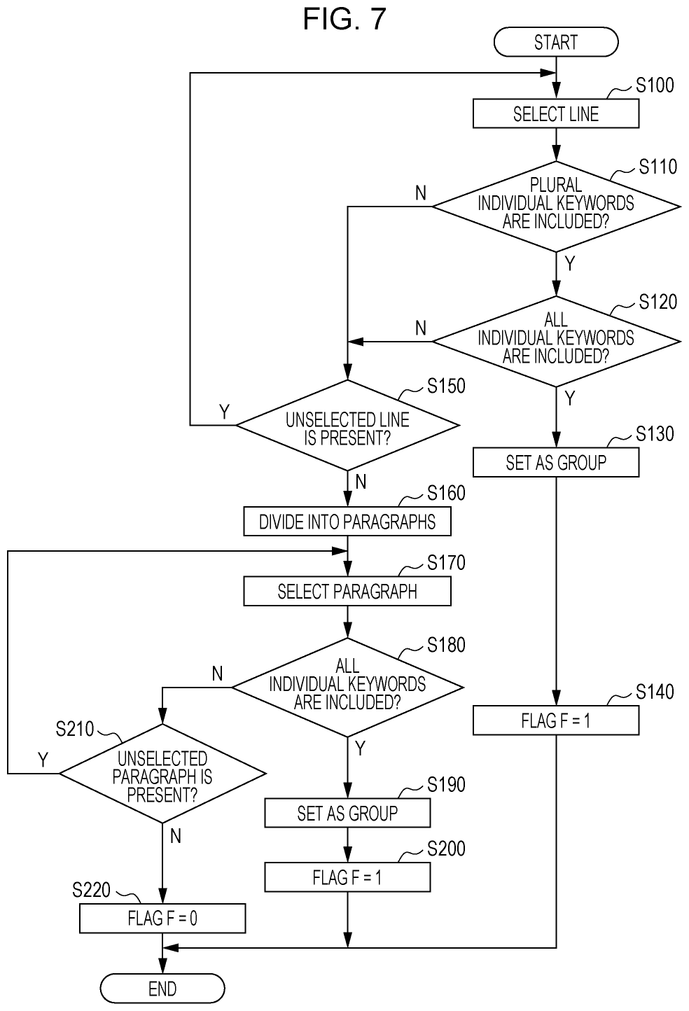

FIG. 7 is a flowchart illustrating an example of a flow of the aggregation processing in step S20 illustrated in FIG. 6.

In step S100 of the aggregation processing, for example, the CPU 41 sequentially selects unselected lines one by one in the order from the line at the highest position to the line at the lowest position in the converted image 20, which is a keyword acquisition target. The line selected in step S100 will hereinafter be referred to as a “selected line”.

In step S110, the CPU 41 determines whether two or more of the individual keywords forming the keyword specified by the user are included in the selected line. When two or more of the individual keywords are included in the selected line, the process continues to step S120.

In step S120, the CPU 41 determines whether all the individual keywords forming the keyword specified by the user are included in the selected line. Note that all the individual keywords forming the keyword specified by the user are not necessarily included in the selected line in a state of being connected to one another. For example, when a keyword that is managed in the keyword table 30 illustrated in FIG. 3 and whose management number is “1” is selected by the user, even if the character string “RATED MAXIMUM VOLTAGE” is not included in the selected line, it is determined that all the individual keywords forming the keyword specified by the user are included in the selected line as long as a character string such as “maximum voltage in rating” or “maximum value of rated voltage” is included in the selected line.

When a person writes a character string in a drawing, the person writes the character string along a line parallel to a direction in which the character string is to be written, and thus, there is a tendency that character strings in the same line are more related to each other than character strings in different lines are. In other words, when all the individual keywords forming the keyword specified by the user are included in the selected line, it is determined that there is a high probability that the keyword is written in a different representing manner in the selected line.

Thus, when all the individual keywords forming the keyword specified by the user are included in the selected line, the process continues to step S130.

In step S130, the CPU 41 sets as small the rectangle 22 as possible that includes the individual keywords included in the selected line and generates a single group of the individual keywords that corresponds to the area indicated by the rectangle 22. As a result, the position at which the keyword specified by the user is written is identified to be in the area of the generated group. The wording “the position at which the keyword specified by the user is written” includes the position at which a character string representing the keyword in a different representing manner is written.

For a processing operation that will be described later, in step S140, the CPU 41 sets the value of a flag F to “1”, the flag F indicating that the area in which the keyword specified by the user is written has been identified, and terminates the aggregation processing illustrated in FIG. 7.

In contrast, when it is determined in the determination processing in step S110 that two or more of the individual keywords are not included in the selected line, and when it is determined in the determination processing in step S120 that two or more but not all of the individual keywords forming the keyword specified by the user are included in the selected line, the process continues to step S150. Note that, when two or more of the individual keywords are included in the selected line, in the subsequent processing, the CPU 41 collectively treats these individual keywords without dividing them.

In step S150, the CPU 41 determines whether there is still an unselected line that has not been selected in step S100 in the converted image 20. When there is an unselected line, since there is a possibility that the keyword representing the item that the user desires to obtain may be included in the unselected line, the process continues to step S100, and the next unselected line is selected in step S100.

Although it has been described that, in step S100, unselected lines are sequentially selected in the order from the line at the highest position in the converted image 20, there is no restriction on the order in which unselected lines are selected, and unselected lines may be sequentially selected in the order from the line at the lowest position toward the line at the highest position in the converted image 20 or may be selected in a random manner.

As described above, there is a tendency that character strings in the same line are more related to each other than character strings in different lines are. Thus, by selecting the lines in the converted image 20 until there is no unselected line, a group that is generated by aggregating individual keywords that are written in the same line is given higher priority for being identified as the area in which the keyword is written than a group that is generated by aggregating individual keywords that are written across different lines.

In contrast, when it is determined in the determination processing in step S150 that there is no unselected line in the converted image 20, the process continues to step S160.

Since it has been determined, through the above processing operations, that it is difficult to generate a group corresponding to the keyword on a line-by-line basis, in the subsequent steps, the aggregation area of the individual keywords is expanded, and it is determined whether generation of a group corresponding to the keyword is capable of being performed on a paragraph-by-paragraph basis. Accordingly, in step S160, the CPU 41 divides the character strings included in the converted image 20 into paragraph units.

The term “paragraph” refers to a range in which a set of contents that are related to one another are written, and a paragraph is formed of a plurality of lines. Paragraphs are displayed so as to be separated from each other by, for example, placing a blank line between the paragraphs in order to indicate that the contents written in one of the paragraphs and the contents written in the other paragraph are different from each other.

Thus, for example, the CPU 41 recognizes a plurality of lines that are included in an area between two blank lines as a single paragraph and divides the character strings included in the converted image 20 into paragraph units. Note that the term “blank line” refers to a line in which no character string is present and a line in which only a character code that corresponds to a space is present.

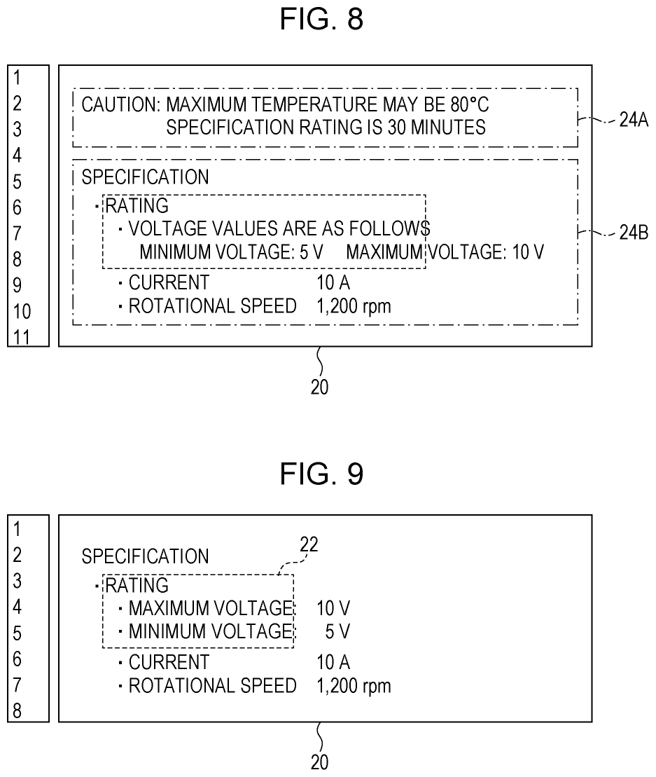

FIG. 8 is a diagram illustrating an example of the converted image 20 that is illustrated in FIG. 2B and that have been divided into paragraph units. In FIG. 8, line numbers are displayed on the left-hand side of the converted image 20 for convenience of description. In the converted image 20 illustrated in FIG. 8, since the first, fourth, and eleventh lines are blank lines, the second and third lines form a paragraph 24A, and the fifth to tenth lines form a paragraph 24B.

Note that a method of dividing the converted image 20 into paragraphs is not limited to that described above, division of the converted image 20 into paragraphs is performed in accordance with how the paragraphs are displayed so as to be separated from one another in the converted image 20.

There is a case where the start position of a character string in the start line of a paragraph is different from the start position of a character string in another line of the paragraph in a direction in which the lines of the paragraph extend. For example, a character string is written in the start line of a paragraph so as to be left-justified, and a character string is written in another line from a position shifted to the right-hand side by a distance corresponding to several characters from the first character in the start line of the paragraph.

In addition, in the case of the converted image 20 in which a symbol (e.g., “▪”) that indicates the start of a paragraph is used in the start line of a paragraph, the converted image 20 is divided into paragraphs by specifying beforehand such a symbol that is used in the start line of each paragraph. The converted image 20 is divided into paragraphs by a method according to an instruction from a user.

In the above case, although it has been described that a plurality of lines that are included in an area between blank lines are recognized as a single paragraph, in the converted image 20 illustrated in FIG. 8, there may be a case where blank lines, which are the first line and the eleventh line, are not provided. In the converted image 20 illustrated in FIG. 8, since the second line is the start line of a paragraph, and the tenth line is the last line of another paragraph, the converted image 20 may be divided into the paragraphs by assuming that there are blank lines before the start line and after the last line.

When the converted image 20 is divided into the paragraphs, in step S170, the CPU 41 sequentially selects unselected paragraphs one by one in order from, for example, the paragraph at the highest position toward the paragraph at the lowest position in the converted image 20. Similar to the order in which unselected lines are selected, there is no restriction on the order in which unselected paragraphs are selected, and the CPU 41 may sequentially select unselected paragraphs in the order from the paragraph at the lowest position toward the paragraph at the highest position in the converted image 20 or may select unselected paragraphs in a random manner. The paragraph selected in step S170 will hereinafter be referred to as “selected paragraph”.

In step S180, the CPU 41 determines whether all the individual keywords forming the keyword specified by the user are included in the selected paragraph. When all the individual keywords forming the keyword specified by the user are included in the selected paragraph, the process continues to step S190.

In step S190, the CPU 41 sets as small the rectangle 22 as possible that includes the individual keywords included in the selected paragraph and generates a single group of the individual keywords that corresponds to the area indicated by the rectangle 22. As a result, the position at which the keyword specified by the user is written is identified to be in the area of the generated group.

In the case where a plurality of the same individual keywords are included in a paragraph, even if the size of the rectangle 22 increases, the CPU 41 generates a group such that one of these same individual keywords that is positioned in a line in which another individual keyword is also included is given priority for being included in the group.

For a processing operation, which will be described later, in step S200, the CPU 41 sets the value of the flag F to “1”, the flag F indicating that the position at which the keyword specified by the user is written has been identified, and terminates the aggregation processing illustrated in FIG. 7.

In contrast, when it is determined in the determination processing in step S180 that all the individual keywords are not included in the selected paragraph, it is assumed that the item that the user desires to obtain is not included in the selected paragraph. Thus, the process continues to step 5210, and in step S210, the CPU 41 determines whether there is still an unselected paragraph that has not been selected in step S170 in the converted image 20.

When there is an unselected paragraph, since there is a possibility that the item that the user desires to obtain may be included in the selected paragraph, the process continues to step S170, and in step S170, the CPU 41 selects an unselected paragraph. In other words, each of the paragraphs is selected from the converted image 20 until a paragraph in which all the individual keywords forming the keyword specified by the user are included is found.

In contrast, when all the individual keywords forming the keyword specified by the user are not included in any one of the paragraphs included in the converted image 20, it is assumed that the keyword specified by the user is not included in the converted image 20. Thus, the process continues to step S220, in step S220, the CPU 41 sets the flag F to “0” and terminates the aggregation processing illustrated in FIG. 7.

In the case where the keyword that is managed in the keyword table 30 illustrated in FIG. 3 and whose management number is “1” is selected by a user, when the aggregation processing illustrated in FIG. 7 is performed on the converted image 20 illustrated in FIG. 8, it is determined first whether there is a line that includes all the individual keywords forming the selected keyword. Since there is no line that includes all the individual keywords in the converted image 20 illustrated in FIG. 8, it is then determined whether there is a paragraph that includes all the individual keywords.

The paragraph 24A includes the individual keywords “RATED” and “MAXIMUM” and does not include the individual keyword “VOLTAGE”, and thus, the paragraph 24A is not considered to be a paragraph that includes all the selected individual keywords. In contrast, the paragraph 24B includes all the selected individual keywords “RATED”, “MAXIMUM”, and “VOLTAGE”, and thus, the area indicated by the rectangle 22 that has the minimal area and that includes the individual keywords “RATED”, “MAXIMUM”, and “VOLTAGE” is identified as the area in which the keyword is written.

In the case of creating a sentence that has the same meaning as a keyword by using individual keywords forming the keyword, the individual keywords forming the keyword are likely to be arranged in a concentrated manner. Thus, the area indicated by the rectangle 22 that has the minimal area and that includes the individual keywords is the area in which the keyword representing the item that the user desires to obtain is written.

Note that, two or more of the individual keywords forming a keyword may sometimes be included in each paragraph depending on the converted image 20, so that there is a case where a plurality of groups are generated. Thus, after it has been determined in step S180 that all the individual keywords forming the keyword specified by the user are included in the selected paragraph, and the processing in step S200 has been performed, the process may continue to step S210. However, in this case, after it has been determined in the determination processing in step S210 that there is no unselected paragraph, if the flag F has already been set to “1”, the processing in step S220 is not performed.

When the aggregation processing in step S20 illustrated in FIG. 6 is terminated, the processing in step S30 is performed.

In the aggregation processing in step S20, when the position at which the keyword specified by the user is written is determined from the converted image 20, the flag F is set to “1”, and when the position is not determined, the flag F is set to “0”.

Thus, in step S30, the CPU 41 determines whether the flag F is set to “1”. When the flag F is set to “1”, the process continues to step S40.

In step S40, the CPU 41 assigns one of the individual keywords aggregated into a group to a representative keyword that represents the individual keywords. The term “representative keyword” refers to the individual keyword that has been written last in the group. Such assignment of a representative keyword is performed on the basis of the fact that, since the value of a keyword is often written after the keyword, when a keyword is divided into individual keywords, and the individual keywords are written in the converted image 20 in a distributed manner, the value of the keyword is often written after one of the individual keywords that has been written last in a group. The representative keyword is an example of a representative character string in the technology disclosed herein.

In other words, assignment of a representative keyword is performed on the basis of the positions at which the individual keywords are written in a group. For example, when the individual keywords in the group are included in the same line, the CPU 41 assigns the rearmost individual keyword in the group, that is, the rightmost individual keyword in the group, to the representative keyword. Note that, in the case of a language such as Arabic in which characters are written from the right to the left, the leftmost individual keyword in a group may be assigned to the representative keyword. In the present exemplary embodiment, for convenience of description, the case of Japanese language will be described as an example.

Even if a character string is written in Japanese, there is a case where the character string is written vertically. In this case, the lowermost individual keyword in a group may be assigned to the representative keyword. In the present exemplary embodiment, for convenience of description, the case where a Japanese character string is written horizontally will be described as an example.

In the case where individual keywords included in a group are distributed over a plurality of lines, the CPU 41 assigns the lowermost individual keyword in the group to the representative keyword. In this case, if two or more of the individual keywords are included in the line including the lowermost individual keyword, the CPU 41 assigns the rightmost individual keyword in the line including these individual keywords, to the representative keyword.

Although the position at which a keyword specified by a user is written is represented by the area of a generated group, the position at which the value of the keyword is written in the converted image 20 is unknown. Thus, in step S50, the CPU 41 acquires, as a value candidate of the keyword, a character string that is presumably the value of the keyword from the character strings included in the converted image 20 in accordance with the relevance between the representative keyword and the value and assigns the acquired value candidate to the generated group.

Although the position at which the value of the keyword is written in the converted image 20 is unknown, the value is positioned near the representative keyword of the corresponding keyword so that the value is visually recognized to be the value of the corresponding keyword. In other words, a value probability that a character string may be the value of a keyword decreases as the distance between the character string and the position where the representative keyword is written increases.

Thus, the CPU 41 extracts character strings that are written in the vicinity of the group including the representative keyword. Here, the wording “character strings that are written in the vicinity of the group” refers to character strings that are included in an area of the converted image 20 excluding the region surrounded by the boundary of the group, that is, the region surrounded by the rectangle 22, and that are included in a predetermined area (value-candidate acquisition area) extending from the outline of the rectangle 22. The value-candidate acquisition area is represented by the distance from the boundary line of the group, and the value-candidate acquisition area is, for example, a value that is set by a user. A user may set the entire area of the converted image 20 as the value-candidate acquisition area. Note that a method of setting the value-candidate acquisition area is not limited to this.

For example, the value-candidate acquisition area may be set so as to include the area in which the value probability is equal to or higher than a predetermined threshold. The value probability is experimentally calculated by using a large number of different converted images 20 and measuring the distance between the boundary line of the group and each value.

As an example, when an area that extends from a generated group by a distance corresponding to one line is set as the value-candidate acquisition area, in the case of the converted image 20 illustrated in FIG. 8, for example, character strings, which are “SPECIFICATION” that is located in a line adjacent to the upper side of the rectangle 22, “FOLLOWS” and “10 V” each of which is located in a line included in the area of the rectangle 22, and “CURRENT” and “10 A” each of which is located in a line adjacent to the lower side of the rectangle 22, are acquired as value candidates. A character string that is located in a line included in the area of the rectangle 22 is included in the value-candidate acquisition area in any case.

In the case of the converted image 20 illustrated in FIG. 8, the rectangle 22 is set in such a manner that the outline of the rectangle 22 is located on “S” of “FOLLOWS”. In this case, “S” may be treated as a character that is included in the group indicated by the rectangle 22 or may be treated as a character that is not included in the group. Since “S” is treated as a character that is not included in the group in this case, the character string “FOLLOWS” is acquired as a value candidate.

In the case where predetermined separators, such as a space, a centered dot “⋅”, and a colon “:”, each of which is used to separate character strings from each other are included in the converted image 20, the CPU 41 separates the character strings from one another with the separators, and extracts value candidates in such a manner that the separators are not included in the value candidates. Thus, in the case of the converted image 20 illustrated in FIG. 8, “10 V” and “CURRENT” rather than“:10 V” and “⋅ CURRENT” are extracted as value candidates.

In step S60, the CPU 41 evaluates the degree of association between each of the value candidates, which have been extracted from the converted image 20 in step S50, and the representative keyword. The degree of association between each of the value candidates and the representative keyword is represented by an evaluation value obtained by performing evaluation with respect to at least one predetermined evaluation item. As an example, the higher the evaluation value of one of the value candidates, the higher the degree of association between the value candidate and the representative keyword.

As described above, the value probability that a value candidate may be the value of a representative keyword decreases as the distance between the value candidate and the position at which the representative keyword is written increases. Thus, the CPU 41 measures the distance between the representative keyword included in the group and each of the value candidates acquired in step S50 and sets the evaluation value of each of the value candidates such that the evaluation value becomes higher as the distance between the representative keyword and the value candidate decreases.

In addition, according to a normal description, the name of an item is displayed first, and then the contents of the item are described. Consequently, the value of a keyword is often written after the keyword rather than before the keyword. Thus, the CPU 41 sets the evaluation value of each of the value candidates such that the evaluation value becomes higher as the position of the value candidate as seen from the keyword is located further toward a direction that is possible when the value candidate is written after the keyword, that is, as the position of the value candidate as seen from the representative keyword is located further toward a rightward direction or a downward direction.

More specifically, a two-dimensional coordinate system using the center of the character string of the representative keyword as the origin is set in the converted image 20, and the magnitude relationship between the evaluation values of the value candidates is set so as to satisfy a relationship of evaluation value of value candidate located in fourth quadrant _{>}evaluation value of value candidate located in third quadrant _{>}evaluation value of value candidate located in first quadrant _{>}evaluation value of value candidate located in second quadrant.

If there is a margin in a drawing, the value of a keyword is likely to be written in a line in which a representative keyword is written so as to be positioned right behind the representative keyword rather than being written in a line different from the line that includes the representative keyword. In addition, in the case where the value of a keyword is written by starting a new line that is different from the line in which the keyword is written, in order to display the value of the keyword such that what item the value indicates is understandable, the value of the keyword is often written on the right side of the representative keyword or below the representative keyword in accordance with the movement direction of the line of sight of a person who reads characters.

Thus, regarding the value candidates located in the fourth quadrant, the evaluation values of these value candidates are set such that the evaluation value of the value candidate that is located on an axis (X-axis) extending in the direction in which the lines extend, that is, the evaluation value of the value candidate positioned in the line in which the representative keyword is written is highest, and such that the evaluation value of each value candidate decreases in a stepwise manner as the position at which the value candidate is written is located further toward a direction from the X-axis direction toward an axis direction (a Y-axis direction) that is perpendicular to the X-axis direction as seen from the origin of the two-dimensional coordinate system, that is, as the position at which the value candidate is written is located further toward the downward direction as seen from the representative keyword. In this manner, even if value candidates are located in the same quadrant, the evaluation values of these value candidates may be changed in accordance with the positions of the value candidates in the quadrant.

In addition, depending on the item that a user desires to obtain, the data type that is the form in which a value is represented may sometimes be predictable beforehand. For example, when the item that a user desires to obtain from a drawing is the rated maximum voltage of a device or the phone number of a company, it is very likely that the value is represented by numerical value. When the item that a user desires to obtain from a drawing is the name of a person in charge, it is very likely that the value is represented by characters. When the item that a user desires to obtain from a drawing is an email address, it is very likely that the value is represented by alphanumeric characters and symbols.

Accordingly, the CPU 41 sets the evaluation value of each of the value candidates in such a manner that, when the possible data type for the value of the item that the user desires to obtain and the acquired data type of each of the value candidates are compared with each other, the evaluation value of the value candidate is higher in the case in which the acquired data type of the value candidate is the same as the expected data type than in the case in which the acquired data type of the value candidate is different from the expected data type.

The possible data type for the value of the item that the user desires to obtain is set beforehand as the data type in the keyword table 30 illustrated in FIG. 3. Thus, when the keyword whose management number is “1” is selected by the user, the CPU 41 sets the evaluation value of the value candidate whose data type is a numerical value to be higher than the evaluation value of the value candidate whose data type is not a numerical value among the acquired value candidates.

The CPU 41 calculates the evaluation values of each of the value candidates with respect to the above-mentioned evaluation items and sets the sum of the evaluation values of each value candidate with respect to the evaluation items to the evaluation value of the value candidate.

In the case of the converted image 20 illustrated in FIG. 8, the highest evaluation value as a value candidate of the rated maximum voltage, which is the item that the user desires to obtain, is given to a character string “10 V” that is located close to the representative keyword “MAXIMUM” on the right-hand side and that includes a numerical value.

Note that the evaluation items that are used in the evaluation of each value candidate are not limited to the distance between the representative keyword and the value candidate, the direction of the value candidate as seen from the representative keyword, and the data type of the value candidate. Any evaluation item may be used as long as the evaluation item represents the degree of association between the value candidate and the representative keyword, and the evaluation accuracy of each value candidate becomes higher as the number of evaluation items increases.

It is not necessary for the CPU 41 to calculate evaluation values with respect to a plurality of evaluation items and may calculate an evaluation value with respect to any one evaluation item. In this case, the time taken for the evaluation of value candidates is reduced more than that in the case where the CPU 41 calculates evaluation values with respect to a plurality of evaluation items. In addition, the CPU 41 may receive information regarding selection of an evaluation item that is used in evaluation of value candidates from a user and may perform evaluation of value candidates by using the selected evaluation item.

In step S70, the CPU 41 refers to the keyword that is associated with the management number selected by the user and the evaluation values of the value candidates, which have been calculated in step S60, and outputs an extraction result for the keyword. As a result, the value candidate that corresponds to the item that the user desires to obtain is output together with its evaluation value, and the information processing illustrated in FIG. 6 is terminated.

For example, the CPU 41 may output the extraction result for the keyword in a comma-separated values (CSV) format and may create a database in which the keyword and the value candidate are associated with each other.

Note that, when the user selects the value that is considered to be correct for the keyword from the value candidates through the input unit 48 by referencing to the evaluation value of the value candidate that has been output, the CPU 41 is informed of this selection result. The CPU 41 that has received the selection result stores, as history information, a combination of the value candidate selected as the correct value and the keyword into the non-volatile memory 44.

In the above-described case, although the user sets beforehand the data type for the keyword to the keyword table 30, the CPU 41 may learn, by using the stored history information, the correspondence relationship between the keyword and the data type of the value by a commonly known machine learning method, and when a new keyword is registered in the keyword table 30, the CPU 41 may automatically set the data type of the new keyword on the basis of learning results.

A machine learning method is an estimation method in which regularity that potentially exists between data and the meaning represented by the data and the meaning represented by unknown data is estimated on the basis of the regularity by repeatedly learning a plurality of data items and the meanings represented by the data items by associating each of the data items and the corresponding meaning with each other.

Note that, when a plurality of groups are generated in the aggregation processing in step S20, the processing operations in step S40 to step S70 may be performed on each of the groups.

In contrast, when the flag F is set to “0” in the determination processing in step S30, the process continues to step S80.

In this case, in order to indicate that a group that includes all the individual keywords forming the keyword specified by the user has not been generated, in step S80, the CPU 41 outputs the fact that a value candidate of the keyword specified by the user has not been acquired from the converted image 20 and terminates the information processing illustrated in FIG. 6.

As described above, the information processing apparatus 10 according to the present exemplary embodiment divides a keyword representing an item that a user desires to obtain into individual keywords and manages the individual keywords in the keyword table 30. Then, the information processing apparatus 10 generates as narrow a group as possible that includes all the individual keywords forming the specified keyword and sets a representative keyword by referencing to the positions of the individual keywords in the group. In addition, the information processing apparatus 10 acquires value candidates from the converted image 20 on the basis of the position of the set representative keyword and calculates the evaluation value of each of the value candidates in accordance with an evaluation item representing the degree of association between the representative keyword and the value candidate. Then, the information processing apparatus 10 outputs the calculation results.

When generating a group, the information processing apparatus 10 attempts to generate a group on a paragraph-by-paragraph basis after checking whether generation of a group is capable of being performed on a line-by-line basis. In the case where two or more of the individual keywords are written in the same line, the information processing apparatus 10 gives priority for being included in the group to the two or more individual keywords written in the same line.

In the case of acquiring the value of a rated minimum voltage from the converted image 20 such as that illustrated in FIG. 9, if a value extraction method in which the individual keywords “RATED”, “minimum”, and “VOLTAGE” are extracted in the order from the upper line to the lower line, and in which a character string that is located on the right-hand side of “minimum”, which is the individual keyword that is extracted last, is set as the value of the rated minimum voltage is employed, “VOLTAGE: 5 V” will be acquired as the value of the rated minimum voltage.

In contrast, in the information processing apparatus 10 according to the present exemplary embodiment, since the fifth line includes the individual keywords “minimum” and “VOLTAGE”, a group such as the rectangle 22 is generated, and “VOLTAGE” in the fifth line is set as the representative keyword. Thus, the character string “5 V” located on the right-hand side of the representative keyword is acquired as the value of the rated minimum voltage.

Although the exemplary embodiment of the present disclosure has been described above, the present disclosure is not limited to the scope described in the exemplary embodiment. Various changes or improvements may be made to the exemplary embodiment within the gist of the present disclosure, and exemplary embodiments obtained by making such changes or improvements to the above exemplary embodiment are also included in the technical scope of the present disclosure. For example, the order of the processing operations may be changed within the gist of the present disclosure.

In the present exemplary embodiment, although a case in which information processing is performed by software has been described as an example, processing equivalent to the flowcharts illustrated in FIG. 6 and FIG. 7 may be implemented in, for example, an application specific integrated circuit (ASIC), and the information processing may be performed by hardware. In this case, speeding up of the processing may be achieved compared with the case where the information processing is performed by software.

In addition, instead of constructing each of the functional units illustrated in FIG. 1 and the keyword DB 16 by the single information processing apparatus 10, for example, the functional units and the keyword DB 16 may be dispersedly located in a plurality of information devices by using cloud computing, and the plurality of information devices may be linked to one another, so that processing equivalent to that performed by the information processing apparatus 10 may be performed.

When a character string is written vertically or when a character string is written from the right to the left, by taking the intent of the present disclosure into consideration, the direction in which a character string is to be read, the direction having been described in the exemplary embodiment, may be changed in accordance with the form in which the character string is written. For example, in the case where description is written vertically in Japanese in a drawing, when individual keywords included in a group are included in the same line, the individual keyword that is located at the lowermost position in the group serves as a representative keyword. In addition, when the individual keywords in the group are distributed over a plurality of lines, the individual keyword that is located at the leftmost position in the group serves as a representative keyword, and when two or more of the individual keywords are included in the line that includes the individual keyword located at the leftmost position, the individual keyword that is located at the lowermost position in the line in which the two or more individual keywords are included serves as a representative keyword.

In the above exemplary embodiment, although a case in which an information processing program is installed in the ROM 42 has been described, the present disclosure is not limited to this case. An information processing program according to the present disclosure may be provided by being recorded in a computer-readable storage medium. For example, the information processing program according to the present disclosure may be provided by being recorded in an optical disc such as a compact disc (CD)-ROM or a digital versatile disc (DVD)-ROM. Alternatively, the information processing program according to the present disclosure may be provided by being recorded in a semiconductor memory such as a universal serial bus (USB) memory or a flash memory. In addition, the information processing apparatus 10 may be configured to acquire the information processing program according to the present disclosure from an external device that is connected to a communication line (not illustrated) via the communication unit 47.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an extraction unit that extracts character strings obtained by converting characters in an image to character codes;
an aggregation unit that aggregates a plurality of first character strings that are included in the character strings extracted by the extraction unit and each of which represents an item that a user desires to obtain into a group by using information items regarding positions of the plurality of first character strings in the image;
an assigning unit that assigns candidates for a second character string that are included in the character strings extracted by the extraction unit and that correspond to the group aggregated by the aggregation unit to the group; and
an output unit that outputs the candidates for the second character string assigned to the group by the assigning unit.

2. The information processing apparatus according to claim 1,
wherein the aggregation unit aggregates the first character strings into the group in such a manner that each of the first character strings is included in the group.

3. The information processing apparatus according to claim 1,
wherein the aggregation unit aggregates the first character strings that are selected in such a manner that a size of a virtual rectangle surrounding and including the first character strings on the image becomes smaller into the group.

4. The information processing apparatus according to claim 2,
wherein the aggregation unit aggregates the first character strings that are selected in such a manner that a size of a virtual rectangle surrounding and including the first character strings on the image becomes smaller into the group.

5. The information processing apparatus according to claim 3,
wherein the aggregation unit aggregates the first character strings in each line, and when each of the first character strings is not included in the aggregated first character strings, the aggregation unit performs aggregation the first character strings into a group on a paragraph-by-paragraph basis in such a manner that each of the first character strings is included in the group.

6. The information processing apparatus according to claim 4,
wherein the aggregation unit aggregates the first character strings in each line, and when each of the first character strings is not included in the aggregated first character strings, the aggregation unit performs aggregation the first character strings into a group on a paragraph-by-paragraph basis in such a manner that each of the first character strings is included in the group.

7. The information processing apparatus according to claim 1,
wherein the assigning unit assigns the candidates for the second character string to the group in accordance with a degree of association between each of the candidates and a representative character string that is set to the group and that represents the first character strings.

8. The information processing apparatus according to claim 2,
wherein the assigning unit assigns the candidates for the second character string to the group in accordance with a degree of association between each of the candidates and a representative character string that is set to the group and that represents the first character strings.

9. The information processing apparatus according to claim 3,
wherein the assigning unit assigns the candidates for the second character string to the group in accordance with a degree of association between each of the candidates and a representative character string that is set to the group and that represents the first character strings.

10. The information processing apparatus according to claim 4,
wherein the assigning unit assigns the candidates for the second character string to the group in accordance with a degree of association between each of the candidates and a representative character string that is set to the group and that represents the first character strings.

11. The information processing apparatus according to claim 5,
wherein the assigning unit assigns the candidates for the second character string to the group in accordance with a degree of association between each of the candidates and a representative character string that is set to the group and that represents the first character strings.

12. The information processing apparatus according to claim 6,
wherein the assigning unit assigns the candidates for the second character string to the group in accordance with a degree of association between each of the candidates and a representative character string that is set to the group and that represents the first character strings.

13. The information processing apparatus according to claim 7,
wherein the degree of association between each of the candidates for the second character string and the representative character string is represented by at least one evaluation item.

14. The information processing apparatus according to claim 13,
wherein a distance between each of the candidates for the second character string and the representative character string is included in a plurality of the evaluation items, and
wherein the degree of association between each of the candidates for the second character string and the representative character string is set in such a manner that the degree of association becomes higher as a distance between the candidate for the second character string and the representative character string decreases.

15. The information processing apparatus according to claim 13,
wherein a direction of each of the candidates for the second character string as seen from the representative character string is included in the plurality of evaluation items, and
wherein the degree of association between each of the candidates for the second character string and the representative character string is set in such a manner that the degree of association becomes higher as the direction of the candidate for the second character string as seen from the representative character string becomes closer to a direction that is set beforehand as a direction in which a character string corresponding to the representative character string is positioned.

16. The information processing apparatus according to claim 13,
wherein data types represented by the candidates for the second character string are included in the plurality of evaluation items, and
wherein the degree of association between each of the candidates for the second character string and the representative character string is set in such a manner that the degree of association is high when the data type represented by one of the candidates for the second character string is a data type that is set beforehand as a possible data type for an item that includes the representative character string.

17. The information processing apparatus according to claim 7,
wherein, when the first character strings in the group are included in the same line, the assigning unit assigns the first character string that is located in a rightward direction in the group to the representative character string,
wherein, when the first character strings in the group are distributed in a plurality of lines, the assigning unit assigns the first character string that is located in a downward direction in the group to the representative character string,
wherein, when the first character strings in the group are distributed in a plurality of lines, and two or more of the plurality of first character strings are included in the line including the first character string that is located in the downward direction in the group, the assigning unit assigns the first character string that is located in the rightward direction in the line including the first character string that is located in the downward direction in the group to the representative character string.

18. A non-transitory computer readable medium storing a program causing a computer to execute a process for information processing, the process comprising:
extracting character strings obtained by converting characters in an image to character codes;
aggregating a plurality of first character strings that are included in the character strings extracted and each of which represents an item that a user desires to obtain into a group by using information items regarding positions of the plurality of first character strings in the image;
assigning candidates for a second character string that are included in the character strings extracted and that correspond to the group aggregated to the group; and
outputting the candidates for the second character string assigned to the group in the assigning.
